(19) United States
(12) Patent Application Publication
(10) Pub. No.: US 2006/0226820 A1
(43) Pub. Date: Oct. 12, 2006

(54) Overcurrent protection for power converters

(76) Inventor: Thomas Farkas, Marlborough, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/372,734

(22) Filed: Mar. 10, 2006

Related U.S. Application Data
(60) Provisional application No. 60/660,272, filed on Mar. 10, 2005.

(51) Int. Cl. G05F 1/571

(52) U.S. Cl. 323/276

(57) ABSTRACT

A power converter includes a main FET and a diode parallel to the main FET. A voltage divider circuit parallel to the main FET enables current to be sensed by a controller for overcurrent protection. A second diode parallel to one element of the voltage divider circuit and in series with a sense element causes the current through the sense element to increase with temperature as current increases through the first diode. In one implantation, a SenseFET comprises a main FET and a parallel mirror FET. A sense resistive element is in series with the mirror FET. A first Schottky diode is placed parallel to the main FET and a second Schottky diode parallel to the mirror FET and in series with the sense resistive element. The first and second diodes are thermally connected such that sensed current increases with increased current through the first Schottky diode. A controller provides overcurrent protection to the converter in response to the level of current through the sense resistive element.

### RELATED APPLICATION

This application claims the benefit of U.S. Provisional Application No. 60/660,272, filed on Mar. 10, 2005. The entire teachings of the above application are incorporated herein by reference.

### BACKGROUND OF THE INVENTION

In power converter circuits, a SenseFET is often used to replace a MOSFET to get a signal proportional to drain current with very low power dissipation and an accuracy significantly better than if the drain-to-source on-resistance of the MOSFET were used for current sensing. It is common in power converter circuits to add a diode parallel to the SenseFET to reduce the power dissipation associated with the SenseFET's body diode's conduction and reverse recovery during switch transitions. The current that flows through this diode affects the ability to determine the current flowing in the converter, which may result in a higher current before an over-current shutdown circuitry has an effect. This increased current limit condition is exacerbated by high temperature.

### SUMMARY OF THE INVENTION

A power converter comprises a main FET, a first diode parallel to the main FET and a voltage divider circuit parallel to the main FET, the voltage divider comprising a first element and a sense element. A second, mirror diode is placed parallel to the first element and in series with the sense element. A controller controls the converter in response to a level of current through the sense element.

The first element may be a mirror FET in a SenseFET. Alternatively, the first element may be a resistor. Both diodes may be thermally connected and conduct more current with temperature rise. A more stable overcurrent protection may thus be provided by the controller. The diodes may be Schottky diodes.

More specifically, in one embodiment, a small Schottky mirror diode (D2) is used to force overcurrent protection to counter the effect of runaway conduction of a larger parallel Schottky barrier diode (D1) stealing current from a SenseFET (M2) under high-temperature, overcurrent conditions. This runaway conduction would otherwise overheat the larger diode and blind the current sensing used by the overcurrent protection circuitry.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a prior art SenseFET and basic application.

FIG. 2 illustrates a prior art SenseFET with parallel Schottky barrier diode.

FIG. 3 illustrates a SenseFET with a parallel Schottky barrier diode and a mirror Schottky diode in an embodiment of the present invention.

FIG. 4 illustrates a power converter embodying the present invention.

FIG. 5 illustrates an alternative embodiment of the invention in which current limit sensing is with a standard MOSFET.

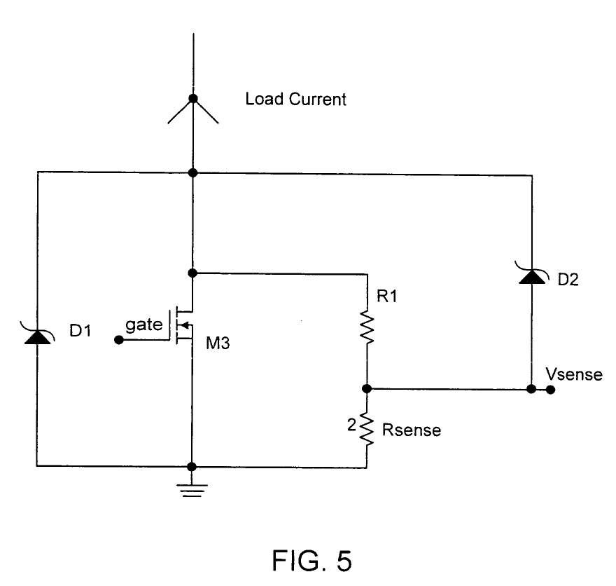

### DETAILED DESCRIPTION OF THE INVENTION

A description of preferred embodiments of the invention follows.

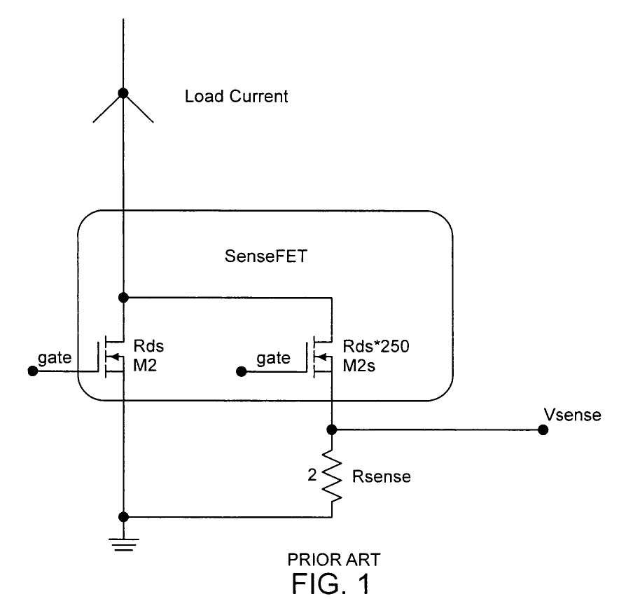

In power converter circuits, a SenseFET is often used to replace a MOSFET and get a signal proportional to drain current with very low power dissipation and an accuracy significantly better than if the drain-to-source on-resistance of the MOSFET were used for current sensing. FIG. 1 shows a basic model of the SenseFET and its usage. The SenseFET contains a large number of standard MOSFET cells (modeled as MOSFET M2 in FIG. 1) and a much smaller number of MOSFET cells (modeled as MOSFET M2s in FIG. 1), which have their source brought out separately to a “sense” terminal Vsense, and which are collectively referred to as the mirror FET. The user connects a sense resistor (Rsense in FIG. 1) between the sense terminal and the source terminal to measure the current through the sensing cells. The current mirror ratio, shown as 250 in FIG. 1, specifies the ratio between the net on-resistance of the sensing cells and the net on-resistance of the main FET cells. The effective current mirror ratio is increased with the addition of sense resistance (Rsense). The resistor value is chosen to give a desired sense voltage as needed for an associated current feedback and/or overcurrent protection, with the tradeoff that a larger value increases the sensitivity of the sense voltage to the tolerance variation of the on-resistance Rds of the main FET.

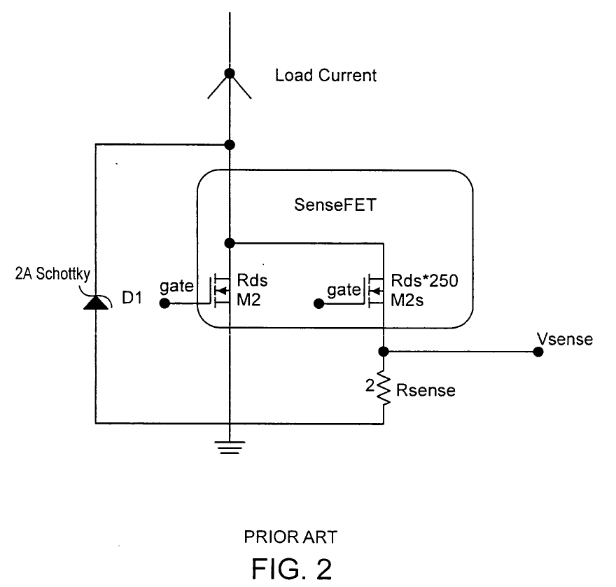

It is also common in power converter circuits to add a Schottky barrier diode, shown as D1 in FIG. 2, between the source and drain of the MOSFET so as to reduce power dissipation associated with the MOSFET's body diode conduction and reverse recovery during switching transitions. Since the Schottky diode is usually located very close to the main FET to minimize inductance that might inhibit commutation between the diode and the FET, it also tends to be thermally well-coupled to the MOSFET. Since the Schottky diode is typically sized to carry the load current only during a short interval (typically 5% of a switching cycle or less), and its conductivity has a positive temperature coefficient (vs a negative temperature coefficient for the MOSFET's on-state conductivity), the designer must take care to ensure that the diode will not steal enough current from the MOSFET to result in thermal runaway of the diode at high load and temperature conditions. Furthermore, when the Schottky diode is used in conjunction with a SenseFET and the sense voltage is used for overcurrent protection, the current through this Schottky diode is invisible to the overcurrent sensing circuit, resulting in higher loading of other devices before overcurrent shutdown occurs.

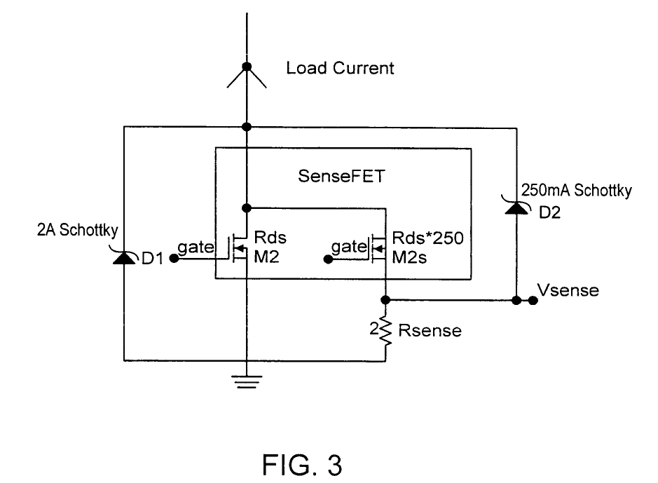

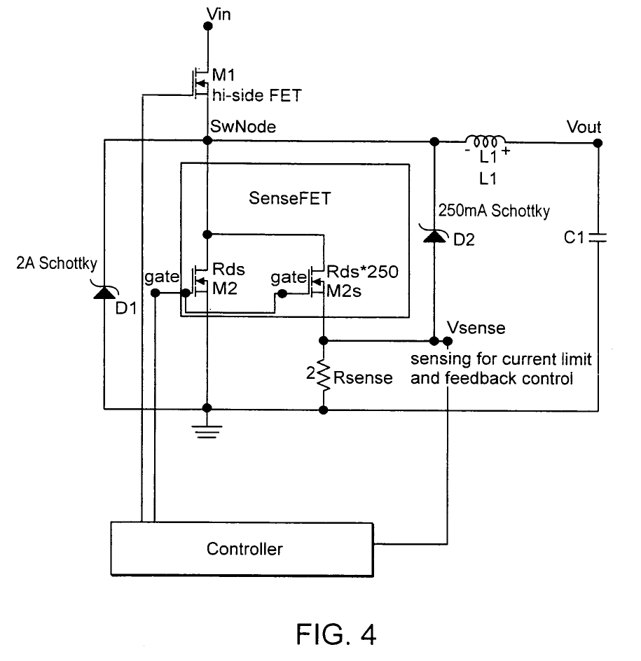

This invention solves the problem described by adding a smaller diode, shown as D2 in FIG. 3, from the drain of the SenseFET to the sense voltage node. Since it is in parallel with the mirror FET M2s, just as the main Schottky D1 is in parallel with the main FET M2, D2 can be referred to as a “mirror Schottky diode”. As temperature and drain-to-source voltage rise due to an overload condition, causing D1 to steal current from M2, D2 also conducts significantly more current, increasing the sense voltage so as to trip the overcurrent protection circuitry (i.e., current limit fold-back or shutdown.) As an example, FIG. 4 shows more details of the application, which is a buck converter, where the gates of MOSFETs M1 and M2 are driven by an integrated control chip, LTC3770EUH manufactured by Linear Technology Corporation. The SenseFET M2/M2s is the NILMS4501N from On Semiconductor. D1 is a DFLS240L and D2 is a SDM20U40, both manufactured by Diodes Inc. The LTC3770 controller is configured to limit the absolute value at the trough (or “valley”) of the sensed current signal to 67+/−10 mV. Since the current ripple is limited by the inductor L1, the valley current limit translates to a limit on the average output current of the converter.

Table 1 illustrates the benefits of this invention by comparing the effect of the diode on the current limit threshold over the range of some critical component tolerances and operating conditions. For all of these cases, 125° C. characteristics of the semiconductors are used, and the on-resistance of M2 (and M2s) is taken to be the maximum value allowed by the manufacturer. (Parameter values are based on datasheet tables as well as curves that account for effects of gate-to-source voltage on current mirror ratio and on-resistance.)

The first two cases are calculated for the load current which gives a sense voltage equal to the minimum current limit threshold of the LTC3770 chip, using the minimum ripple condition (corresponding to low output voltage) and the minimum 125° C. value of the current mirror ratio. Addition of the diode in case 2 is shown to reduce the DC current limit threshold by 7% from 8.9 A to 8.3 A. In cases 3 and 4, however, as conditions and tolerances allow higher currents to increase the drain-to-source voltages, the mirror diode has a significantly larger effect.

In cases 3 and 4, the current ripple, current mirror ratio and the sense voltage threshold are all taken to be their maximum values, and addition of the diode in case 4 reduces the DC current limit threshold by 19% from 18.5 A to 15.0 A.

The tolerance of the current limit has effectively been reduced by the diode taking a bigger reduction out of the high-end of the current limit threshold variation. The diodes do not have I-V characteristics specified above 125° C., but it is clear that both would play a larger role as both on-resistance and diode conductivity increases. Thus, the “mirror” diode significantly increases the capability of the converter to protect itself from high overload current conditions.

TABLE 1
Tabulated analysis results based on 125° C. component specifications,
and maximum M2 on-resistance.

| | Case | | | |
|---|---|---|---|---|
| | 1 | 2 | 3 | 4 |
| DC load current | 8.9 | 8.3 | 18.5 | 15.0 |
| Ripple Current Amplitude | 0.5 | 0.5 | 2.5 | 2.5 |
| Valley Current | 8.4 | 7.8 | 16.0 | 12.5 |
| D1 current | 0.3 | 0.3 | 2 | 2 |
| M2 Drain current (valley) | 8.1 | 7.4 | 14.0 | 10.5 |
| M2 Drain-to-source voltage | 0.223 | 0.205 | 0.385 | 0.289 |
| Mirror Ratio | 211 | 211 | 287 | 287 |
| Mirror FET M2s on-resistance | 5.82 | 5.82 | 7.92 | 7.92 |
| Sense resistor current | 00.0285 | 0.0285 | 0.0385 | 0.0385 |
| Sense resistor voltage | 0.057 | 0.057 | 0.077 | 0.077 |
| Mirror FET drain-source voltage | 0.166 | 0.148 | 0.308 | 0.212 |
| Mirror FET current | 0.028 | 0.025 | 0.039 | 0.027 |
| Mirror Diode D2 Current | | 0.003 | | 0.012 |

Note that a good thermal connection most from the mirror diode D2 to the SenseFET M2 and/or the main diode D1 is needed to make this solution effective. For example, in the circuit board layout for the circuit of FIG. 4, D2 is adjacent to M2, and D1 is located directly under M2, separated by a 0.040″ PCB with 6 layers of two-ounce copper.

This solution is also applicable to current limit sensing with a standard MOSFET using the on-resistance of the MOSFET. Here too, a parallel Schottky barrier diode could blind the current limit circuit at high temperatures. If the MOSFET voltage is divided down by a pair of resistors, then the top resistor plays a role similar to that of the mirror MOSFET of FIGS. 1-4, and a smaller Schottky diode could, by extension, be placed across the top resistor of this divider, but located on the circuit board so that it is thermally well coupled to the main MOSFET and the main Schottky diode, giving similar benefits as described above.

While this invention has been particularly shown and described with references to preferred embodiments thereof, it will be understood by those skilled in the art that various changes in form and details may be made therein without departing from the scope of the invention encompassed by the appended claims.

1. A power converter comprising:
a main FET;
a first diode parallel to the main FET;
a voltage divider circuit parallel to the main FET comprising a first element and a sense element;
a second, mirror diode parallel to the first element and in series with the sense element; and
a controller that controls the converter in response to level of current through the sense element.

2. The power converter of claim 1 wherein the first element is a mirror FET.

3. The power converter of claim 2 wherein the main FET and the mirror FET comprise a SenseFET.

4. A power converter as claimed in claim 1 wherein the first element is a resistor.

5. A power converter as claimed in claim 1 wherein the controller provides overcurrent protection.

6. The power converter as claimed in claim 1 wherein each of the first diode and the second diode conducts more current with temperature rise.

7. The power converter of claim 6 wherein the first diode and second diode are thermally connected.

8. The power converter of claim 1 wherein each of the first diode and second diode is a Schottky diode.

9. A power converter comprising:
a SenseFET comprising a main FET and a parallel mirror FET;
a sense resistive element in series with the mirror FET;
a first Schottky diode parallel to the main FET;
a second, mirror Schottky diode parallel to the mirror FET and in series with the sense resistive element, the first diode and the second diode being thermally connected; and
a controller that provides overcurrent protection to the converter in response to level of current through the sense resistive element.

10. A method of power conversion comprising:
providing a first diode parallel to a main FET;
sensing voltage in a voltage divider circuit parallel to the main FET, the voltage divider circuit comprising a first element and a sense element;
varying current through the sense element with a second, mirror diode parallel to the first element; and
controlling the converter in response to level of current through the sense element.

11. The method of claim 10 wherein the first element is a mirror FET.

12. The method of claim 11 wherein the main FET and the mirror FET comprise a SenseFET.

13. The method of claim 10 wherein the first element is a resistor.

14. The method of claim 10 wherein the controller provides overcurrent protection.

15. The method of claim 10 wherein each of the first diode and the second diode conducts more current with temperature rise.

16. The method of claim 15 wherein the first diode and second diode are thermally connected.

17. The method of claim 10 wherein each of the first diode and second diode is a Schottky diode.
